(19) United States
(12) Patent Application Publication
(10) Pub. No.: US 2015/0365575 A1
(43) Pub. Date: Dec. 17, 2015

(54) LIFELOG CAMERA AND METHOD OF CONTROLLING SAME ACCORDING TO TRANSITIONS IN ACTIVITY

(71) Applicant: Sony Corporation, Tokyo (JP)

(72) Inventors: Håkan Jonsson, Hjärup (SE); Ola Thörn, Limhamn (SE); Kåre Agardh, Lund (SE); Magnus Midholt, Lund (SE); Erik Westenius, Lund (SE); David de Léon, Lund (SE)

(21) Appl. No.: 14/303,664

(22) Filed: Jun. 13, 2014

(51) Int. Cl. H04N 5/232; H04N 5/77; G06K 9/00; H04N 5/225

(52) U.S. Cl. CPC H04N 5/232; H04N 5/2251; H04N 5/772; H04N 5/23293; G06K 9/00382; H04N 5/23219; G06K 2009/00395

(57) ABSTRACT

A lifelog camera is configured to capture a digital image without user input that commands the capturing of the digital image. The lifelog camera includes a control circuit configured to detect a state transition in a signal from a sensor, the state transition indicative of a change in user activity; a camera module that captures the digital image under the control of the control circuit in response to the detection of the state transition; and a memory in which the digital image is stored.

### TECHNICAL FIELD OF THE INVENTION

The technology of the present disclosure relates generally to lifelog cameras and, more particularly, to a lifelog camera that is controlled to take photos in response to activity transitions.

### BACKGROUND

A lifelog camera is a camera device that is typically worn by a user and used to capture photos that serve a photographic memory of events occurring near the user. Conventional lifelog cameras are configured to capture images on a timed basis. In some devices, for example, an image is captured every 30 seconds. If left to take pictures over the course of several hours or an entire day, the lifelog camera could take hundreds or thousands of pictures at the predetermined time intervals. Under this approach, many of the images captured by conventional lifelog cameras are not very interesting. Therefore, a lifelog camera's memory may become filled with photos that are not of interest to the user. More compelling moments may occur rather quickly and between the timed increments for taking a photo. However, it is difficult to determine when those compelling moments are occurring.

One proposed way to increase the appeal of stored images is to evaluate the photos for visual content that is worth retaining, such as images containing people or certain types of objects. The rest of the images may be deleted. An issue with this approach is that the approach is processor intensive and consumes power that reduces battery life.

Another proposed technique is to synchronize the taking of photos to the location of the device, such as locations predetermined to have interest or locations to which the user has not traveled before. But this makes assumptions about locations that may not lead to an interesting depiction of the user's life events. That is, in this approach, the resulting images may not fully “tell” the user's story. Also, some new locations (e.g., a parking lot) may be rather mundane.

Another approach is to reduce the time interval between capturing photos, but these leads to capturing too much data and at the wrong occasions. This may be annoying to the user, and consumes battery life and data storage space.

### SUMMARY

The disclosed techniques for controlling operation of a lifelog camera include detecting changes in user activity or nearby activity as a trigger for taking photos. Detecting changes in user activity or nearby activity serves as a proxy for identifying moments that may contain interesting subject matter for a photo. As the subject matter of photos increases in interest, the favorability of the user experience with the lifelog camera product also will increase. Therefore, the disclosed techniques are designed to attempt to capture images with interesting subject matter, or at least a higher percentage of interesting images than if only a time-based approach were used. As part of the disclosed techniques, changes in activity—as detected from transitions in motion detection, biofeedback detection or other sensor detections—are used to trigger camera activation.

According to one aspect of the disclosure, a method of capturing and storing a digital image with a lifelog camera that is configured to capture the digital image without user input that commands the capturing of the digital image includes detecting a state transition in a signal from a sensor, the state transition indicative of a change in user activity; capturing the digital image with a camera module of the lifelog camera, the capturing triggered by the detection of the state transition; and storing the digital image in a memory.

According to one embodiment, the method further includes detecting multiple transitions between respective stages of an activity sequence carried out by the user and, for each detected transition, capturing and storing an image.

According to one embodiment, the method further includes monitoring multiple signals each from a respective sensor and the detecting made if any one of the signals undergoes a state transition indicative of a change in user activity.

According to one embodiment, the method further includes monitoring multiple signals each from a respective sensor and the detecting made if changes in two or more of the signals are together indicative of the change in user activity.

According to one embodiment of the method, the sensor includes at least one of a motion sensor that detects motion of the user, a biometric sensor, an electric field sensor, or a magnetic field sensor.

According to another aspect of the disclosure, a method of capturing and storing a digital image with a lifelog camera that is configured to capture the digital image without user input that commands the capturing of the digital image includes detecting a state transition in a signal from an electric field sensor or a magnetic field sensor, the state transition indicative of one of a change in user activity or a change in activity near the user; capturing the digital image with a camera module of the lifelog camera, the capturing triggered by the detection of the state transition; and storing the digital image in a memory.

According to one embodiment, the method further includes monitoring the signal from the electric field sensor or the magnetic field sensor and monitoring a signal from an additional sensor, the detecting made if changes in the monitor signals are together indicative of the change in activity.

According to one embodiment of the method, the additional sensor includes at least one of a motion sensor that detects motion of the user or a biometric sensor.

According to another aspect of the disclosure, a lifelog camera is configured to capture a digital image without user input that commands the capturing of the digital image, the lifelog camera includes a control circuit configured to detect a state transition in a signal from a sensor, the state transition indicative of a change in user activity; a camera module that captures the digital image under the control of the control circuit in response to the detection of the state transition; and a memory in which the digital image is stored.

According to one embodiment of the lifelog camera, the control circuit is further configured to detect multiple transitions between respective stages of an activity sequence carried out by the user and, for each detected transition, command the capture and storage of an image.

According to one embodiment of the lifelog camera, the control circuit is further configured to monitor multiple signals each from a respective sensor and the camera module is commanded to capture the digital image if any one of the signals undergoes a state transition indicative of a change in user activity.

According to one embodiment of the lifelog camera, the control circuit is further configured to monitor multiple signals each from a respective sensor and the camera module commanded to capture the digital image if changes in two or more of the signals are indicative of the change in user activity.

According to one embodiment of the lifelog camera, the sensor includes a motion sensor that detects motion of the user.

According to one embodiment of the lifelog camera, the sensor includes a biometric sensor.

According to one embodiment of the lifelog camera, the biometric sensor includes at least one of a galvanic skin response sensor or a pulse rate monitor.

According to one embodiment of the lifelog camera, the sensor includes at least one of an electric field sensor or a magnetic field sensor.

According to another aspect of the disclosure, a lifelog camera is configured to capture a digital image without user input that commands the capturing of the digital image, the lifelog camera includes a control circuit configured to detect a state transition in a signal from an electric field sensor or a magnetic field sensor, the state transition indicative of one of a change in user activity or a change in activity near the user; a camera module that captures the digital image under the control of the control circuit in response to the detection of the state transition; and a memory in which the digital image is stored.

According to one embodiment of the lifelog camera, the control circuit is further configured to monitor the signal from the electric field sensor or the magnetic field sensor and monitor a signal from an additional sensor, the camera module commanded to capture the digital image if changes in the monitor signals are together indicative of the change in activity.

According to one embodiment of the lifelog camera, the additional sensor includes at least one of a motion sensor that detects motion of the user or a biometric sensor.

### BRIEF DESCRIPTION OF THE DRAWINGS

FIG. 1 is a schematic block diagram of a lifelog camera that employs changes in user activity or nearby activity as a trigger for taking photos.

FIG. 2 is a flow diagram of camera control functions carried out by the lifelog.

### DETAILED DESCRIPTION OF EMBODIMENTS

Embodiments will now be described with reference to the drawings, wherein like reference numerals are used to refer to like elements throughout. It will be understood that the figures are not necessarily to scale. Features that are described and/or illustrated with respect to one embodiment may be used in the same way or in a similar way in one or more other embodiments and/or in combination with or instead of the features of the other embodiments.

Described below in conjunction with the appended figures are various embodiments of an electronic device and method of controlling the electronic device to take photographs. The electronic device is typically—but not necessarily—a dedicated lifelog camera. In other embodiments, the electronic device may be some other portable electronic device such as, but not limited to, a mobile telephone, a tablet computing device, a gaming device, a digital point-and-shoot camera, or a media player.

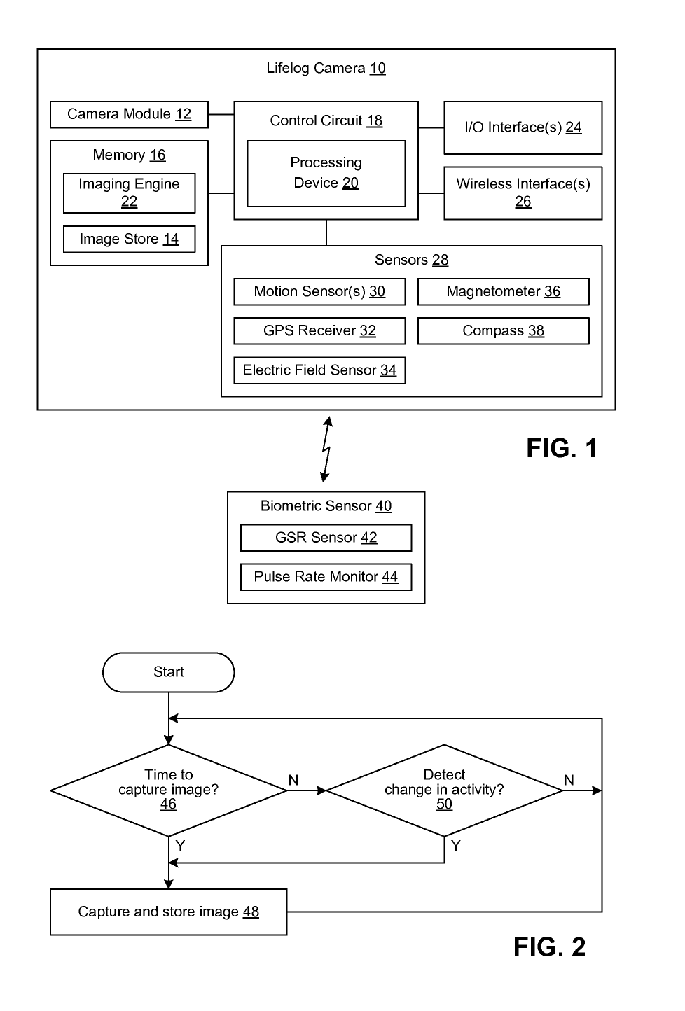

With initial reference to FIG. 1, illustrated is a schematic block diagram of an exemplary electronic device configured as a lifelog camera 10. The lifelog camera 10 may pin or clip to an article of clothing that is worn by the user. In other arrangements, the lifelog camera 10 is configured as a bracelet or wristband, a ring, a headband, eyeglasses, an article of clothing, a piercing, etc.

The lifelog camera 10 includes a camera module 12. The camera module 12 includes appropriate optics and a sensor for imaging a scene to generate still images and, in some cases, video. Although not illustrated, a microphone may be present to capture a sound component for the video. Images and video captured by the camera module 12 may be stored in an image store 14 of a memory 16.

The lifelog camera 10 includes a control circuit 18 that is responsible for overall operation of the lifelog camera 10, including controlling when to capture images with the camera module 12. In one embodiment, the control circuit 18 includes a processor 20 that executes operating instructions. In one embodiment, control over whether to capture and store an image is embodied as part of an imaging engine 22 that is also stored in memory 16.

The imaging engine 22 may be embodied in the form of an executable logic routine (e.g., lines of code, a software program, firmware, etc.) that is stored on a non-transitory computer readable medium (e.g., the memory 16) of the lifelog camera 10 and that is executed by the control circuit 18. The described operations may be thought of as a method that is carried out by the lifelog camera 10.

The processor 20 of the control circuit 18 may be a central processing unit (CPU), a microcontroller, or a microprocessor that executes code in order to carry out operation of the lifelog camera 10. The memory 16 may be, for example, one or more of a buffer, a flash memory, a hard drive, a removable media, a volatile memory, a non-volatile memory, a random access memory (RAM), or other suitable device. In a typical arrangement, the memory 16 includes a non-volatile memory for long term data storage and a volatile memory that functions as system memory for the control circuit 18. The memory 16 may exchange data with the control circuit 18 over a data bus. Accompanying control lines and an address bus between the memory 16 and the control circuit 19 also may be present. The memory 16 is considered a non-transitory computer readable medium.

The lifelog camera 10 may include interfaces for establishing communication with another device, such as a computer, a mobile phone, a wireless router for establishing Internet access, etc. An exemplary interface is an input/output (I/O) interface 24 in the form of an electrical connector and interface circuitry for establishing connectivity to another device using a cable. A typical I/O interface 24 is a USB port. Operating power and/or power to charge a battery (not shown) of the lifelog camera 10 may be received over the I/O interface 24. The battery may supply power to operate the lifelog camera 10 in the absence of an external power source. Another exemplary interface is a wireless interface 26. The wireless interface 26 may be, for example, an interface 26 that operates in accordance with Bluetooth standards, WiFi standards, or another wireless standard. Another wireless interface 26 may be an intrapersonal area network, such as a body area network (BAN). Multiple wireless interfaces 26 may be present to operate over multiple standards (e.g., two or more of a BAN, Bluetooth and WiFi).

The lifelog camera 10 may include a display for displaying captured images and for assisting the user in adjusting settings. However, it is contemplated that the lifelog camera 10 will not include a display and images are viewed using a connected device or after transferring the images from the lifelog camera to another device.

The lifelog camera 10 may include one or more sensors 28 that sense or determine various conditions related to the lifelog camera 10. In the illustrated embodiment, the one or more sensors 28 are illustrated as part of the lifelog camera 10. In other embodiments, sensing components may be in another device that communicates with the lifelog camera 10. For instance, an accelerometer assembly that provides data input to the lifelog camera 10 may be part of a mobile phone carried by the user or may be part of a bracelet or other article that is worn by the user.

An exemplary sensor 28 includes a motion sensor 30, such as one or more accelerometers, one or more gyros, etc. Another exemplary input includes a position data receiver, such as a global positioning system (GPS) receiver 32, used to assist in determining the location of the lifelog camera 10. Another exemplary input includes an electric field sensor 34 that detects changes in an electric field at the lifelog camera 10. Changes in electric field may be caused by an object (e.g., another electronic device) or a person approaching or moving away from the lifelog camera 10, or by changes in electric energy consumption by electrical devices (e.g., lights or machines). Another exemplary input includes a magnetometer 36 that detects changes in a magnetic field at the lifelog camera 10. Changes in magnetic field may be caused by an object (e.g., another electronic device) or a person approaching or moving away from the lifelog camera 10, or by changes in energy-consuming devices. Another exemplary input includes a compass 38 that detects changes in direction of the lifelog camera 10.

The lifelog camera 10 also may receive data from external sensors over a wired or wireless interface. For instance, a biometric sensor 40 worn by the user may transmit biofeedback data to the lifelog camera 10 via the wireless interface 26. The biometric sensor 40 may be worn by the user and may be configured as a bracelet or wristband, a ring, a headband, eyeglasses, an article of clothing, a piercing, or some other form factor. Exemplary data that may be received from the biometric sensor 40 include changes in galvanic skin response (GSR) of the user as monitored by a GSR sensor 42 and/or changes in pulse rate of the user as monitored by a pulse rate monitor 44. Other exemplary data that may be received from the biometric sensor 40 include, but are not limited to, changes in pupil dilation and/or eye movement, changes in brain wave activity, changes in blood pressure, changes in body temperature, changes in muscle contraction, or any other measurable response from the user.

With additional reference to FIG. 2, illustrated is a flow diagram representing steps that may be carried out by the lifelog camera 10 to control the capturing and storing of images. Although illustrated in a logical progression, the illustrated blocks may be carried out in other orders and/or with concurrence between two or more blocks. Therefore, the illustrated flow diagram may be altered (including omitting steps) and/or may be implemented in an object-oriented manner or in a state-oriented manner.

The logical flow may start in block 46. In block 46, a determination may be made as to whether a time-based image should be captured. In one embodiment, the lifelog camera 10 may be configured to capture images at predetermined intervals (e.g., once every 20 seconds or once every 30 seconds) even if the lifelog camera 10 is also configured to capture images based on other criteria. The capturing of images based on time may be turned on or off by the user. Therefore, the determination in block 46 may include determining if a timed image capture function is turned on and, if so, determine if a predetermined time interval between image captures has elapsed to implement a time-based schedule for capturing images.

If a positive determination is made in block 46, the logical flow may proceed to block 48. In block 48, an image is captured using the camera module 12 and a corresponding digital photograph is stored in the image store 14. The images that are captured in block 48 are taken automatically and without user involvement to command the taking of the image (e.g., without user input such as touching a shutter button).

If a negative determination is made in block 46, the logical flow may proceed to block 50. In block 50, a determination is made as to whether there is a detectable change in activity of the user or in activity near the user. If there is a change in user activity or activity near the user, a positive determination may be made in block 50 and the logical flow may proceed to block 48 where an image is captured and stored. In one embodiment, the stored image is tagged with metadata to indicate that the image was captured in response to activity detection. In this manner, the image may be found using a search and distinguished from images that were captured in a time-based manner. Also, the metadata may indicate the type of activity that triggered the capturing of the image to enhance searchability of images based on the nature of the detected activity.

As indicated, there may be more than one type of change in activity that triggers a positive determination in block 50. One type of change in activity includes an activity change related to the user. Another type of change in activity includes an activity change near the user. These types of changes in activity will be discussed in turn.

Detection of changes in activity related to the user includes detections from one or more of the sensors 28, 40 that result from changes in user behavior or changes in biometrics. In one embodiment, the changes that are detected and that trigger camera operation relate to movement of the user. But it is possible that activity related to the user other than movement-based activity may lead to a positive determination in block 50.

In one embodiment, if a change in a signal from any one of several monitored sensors 28, 40 indicates a change in user-based activity, or state transition, then the positive determination may be made. Exemplary signals that may be monitored for this purpose include, but are not limited to, an output signal from the motion sensors 30, an output signal from the GSR sensor 42 and an output signal from the pulse rate monitor 44. Other signals from other types of sensors also may be monitored. To detect a state transition in the signal from any one of the monitored signals, a change threshold may be established for each monitored signal. If one of the signals includes sensing data that represents a change in a corresponding monitored characteristic (e.g., motion characteristic, heart rate characteristic, etc.) that exceeds the threshold established by the corresponding threshold value, then a positive determination in block 50 may result. The thresholds may be quantified and/or the data from each signal may be normalized as is appropriate for each monitored characteristic. For instance, a threshold for pulse rate may be a rise in pulse rate of a predetermined number of beats (e.g., 5 or 10 beats) in a predetermined amount of time (e.g., 20 seconds).

In one implementing embodiment, the imaging engine 22 may include a transition detection module for each monitored signal from a respective one of the sensors 26, 40. Each transition detection module monitors the corresponding signal for a state transition in the signal. The transition detectors may apply the foregoing threshold-based approach to detecting a change in activity or more sophisticated approaches to detect specific types of changes in activity. The transition detectors also may filter out routine activity from resulting in a positive determination (e.g., filter out typing on a keyboard, but make a positive determination for standing up or shaking another person's hand).

In one embodiment, a transition detector is configured to monitor the signals from more than one sensor 28, 40. In this embodiment, the transition detector monitors for a combination of changes in the monitored signals that indicate a change in user activity. For instance, the transition detector may generate a positive detection if at least one biometric signal (e.g., the output from the GSR sensor 42 and/or the output from the pulse rate monitor 44) and the signal from the motion sensor 30 change in a manner that collectively indicate a change in activity by the user. Another combination of signals that may indicate a change in activity is a change in detected electric field based on the signal from the electric field sensor 34 and a change in movement from the motion sensor 30. Another combination of signals that may indicate a change in activity is a change in detected electric field based on the signal from the electric field sensor 34 (or heading from the compass 38) and a change in pulse rate, a change in GSR or a change in other monitored biometric.

The transition detectors may be implemented to detect shifts in user activity as a trigger for taking one or more photos (or to take video) as opposed to taking photos in a time-based manner. Shifts in user activity indicate the potential for something to be happening by the user or near the user. Exemplary shifts in activity include starting to walk, the act of sitting down, starting to run, or the act of stopping a walk or run. The shifts in activity that the lifelog camera 10 is configured to detect and take responsive images may be considered transitionary activities, which are also referred to as changes in a state of activity or as micro-activities that are from a larger event cycle experienced by the user. In this manner, images may be captured for multiple transitions between respective stages of an activity sequence as will be described in several examples that follow.

By capturing photos at these moments, while the user is experiencing an event, it is contemplated a more meaningful sequence of photos may be captured to create an image record of the event. These images assist in depicting the user's “life story” in a more compelling manner than a time-based approach. The events that trigger the capturing of one or more images may be events that are out of the ordinary for the user and may be events that are rather routine for the user. For instance, the activity may as routine as getting onto a bus used by the user for daily commuting. But capturing images of this event may be worthwhile so the user can recall the bus driver and fellow bus riders from each day.

Following the example of getting onto a bus, the event may start with the user at relative rest, such sitting on a bench while waiting for the bus to arrive. At this point, the user's pulse may be steady and the output from the motion sensor 30 may be relatively steady. When the bus arrives, the user may stand up. The act of standing may be detected as a change in user activity from the output from the motion sensor 30. This detection may trigger the capturing of an image. The user may then start to walk toward the bus and this change in activity may be detected from the output of the motion sensor 30 and an increased pulse rate. This detection may trigger the capturing of an image. Similarly, ascending the steps of the bus may be detected as another change in activity and a corresponding image may be captured. The user may pay the bus fare, which might be detected by a change in GSR, and a corresponding image may be captured. The acts of starting to walk to an available seat and sitting down also may result in detections in changes in user activity and corresponding images may be captured at those times.

As another example, the user may wear the lifelog camera 10 while jumping into a pool. As part of this overall action sequence, the user runs to build speed for the jump. The motion sensor 30 may detect the start of the run and then detects the transition to a jump. Corresponding images may be captured for both of these detections. When the user makes contact with the water, a sudden deceleration may be detected and another image may be captured. Swimming back to the surface may result in an increased heart rate that also triggers the capturing of a photo. Then, climbing up a ladder to exit the pool may result in other motion sensor or biometric feedback that triggers the taking of one or more photos. In all, this sequence could occur in a time span between the scheduled image captures of a time-based approach or when only one image is scheduled during the sequence. By comparison, the disclosed technique would capture multiple images at moments of interest.

As another example, the user may be seated on an airplane that is taxing toward a take-off position. During this time, the motion sensor 30 detects little activity and the inputs from the GSR sensor 42 and pulse rate monitor 44 may be relatively steady. But when the plane starts to accelerate for the take-off, the motion sensor 30 may detect the change in movement and the pulse rate and/or GSR of the user may change. These detections may trigger the capturing of one or more images.

In one embodiment, the images that are captured as a result from detecting a change in user activity are standard digital photographs. In another embodiment, most activity changes that are detected will still result in the capture of a standard digital photograph but, for some occasions, the transition detector may further detect changes in the data from the sensors 26, 40 that triggers modified image capturing instead of standard image capturing. In one example, the detection of relatively fast activity or the detection of abrupt transitions during an activity sequence may result in the capture of video, the capture of a slow motion movie, or the capture of multiple images per detected transition in user activity. The capture of video, and especially slow motion video, may be accomplished by implementing the camera module 12 with a multi-array camera. By firing one camera of the multi-array camera at a time, a low resolution, slow motion movie may be capture. Other uses of the multi-array camera may be used for other forms of modified image capturing. For instance, plural cameras of the multi-array camera may be activated at the same time to capture a high resolution image. As another example, a high dynamic range (HDR) picture may be captured by activating plural cameras of the multi-array camera with respective exposure settings that differ from camera to camera.

As mentioned, one type of change in activity that leads to the capturing and storing of an image relates to a change in user activity. In addition to or instead of detecting changes in user activity, changes in activity near the user may result in a positive determination in block 50. For example, a change in a Bluetooth connection or a WiFi connection may trigger the capturing of an image. It is also possible to analyze audio signals output by a microphone for changes in activity near the user. As another example, a change in electric or magnetic field may trigger the capturing of an image (with or without input indicative of user movement or action).

Focusing attention on electrical and magnetic fields, various electrical and magnetic fields are omnipresent. These fields are typically generated by electrical appliances, cables, portable devices, etc.

The following portion of the description will focus on sensing variations in electric field as a trigger for capturing and storing an image. These techniques may be similarly applied to sensing variations in magnetic field as a trigger for capturing and storing an image. Materials, objects, people and electronic devices in an environment with electrical fields will have voltage potentials relative to other such items in the environment. These voltage potentials will vary depending on item size, position and movement, and whether the item is electrically connected to other items. Additionally, an electrical field (EF) is generated in the presence of a voltage potential or a current flow. As an example, different people and different user activities will result in different EF field strengths based on the person's size, movement or lack of movement, and body position (e.g., holding one's arms up versus holding one's arms down, etc.).

A relatively simple way of measuring electrical fields includes using a standard radio receiver used to receive broadcast transmissions (e.g., AM or FM transmissions). The power consumption of a pure EF sensing function is relatively low (e.g., on the order of a couple of milliwatts). Another technique involves using an antenna and a sensing circuit. An exemplary sensing circuit includes a capacitor having its poles respectively connected to the EF antenna and a reference potential. A voltage meter that measures the voltage across the capacitor will sense variations in the surrounding electric field. Analog signals from the voltmeter may be converted to a digital signal using an analog to digital (A/D) converter. The digital signal may be analyzed using digital signal processing and statistical analysis to identify and classify features and variations of the sensed electric field. Continuous or periodic scanning of the EF environment may be made.

A change in EF environment above a predetermined threshold (e.g., a state transition in a signal from the EF sensor 34) may be indicative of an interesting moment for camera operation. Therefore, a transition detection module of the imaging engine 22 may be configured to detect electrical field variations to generate a positive result in block 50 so that an image is captured and stored using the lifelog camera when certain changes in the electric field are detected.

For instance, electrical field variations may indicate a change in the environment near the user. This may be a moment worth capturing one or more images using the lifelog camera. In one exemplary situation, electric field sensing may identify when the user enters a new environment, such a different room in a building, goes from outside to inside or from inside to outside, or makes some other change in environment. These environment changes may be detected by sensing variations in electric field and may trigger the capturing of an image.

The transition detection module of the imaging engine 22 that is configured to monitor variations in electric field may classify different activities based on different types of changes in the EF environment. For example an EF environment that fluctuates over time might be a result of some sort of movement or activity. Therefore, in this situation, the lifelog camera 10 may be controlled to take a series of still images or record video. But sudden changes in monitored EF may indicate different types of changes (e.g., an appliance or lights being turned on or off) and this detection may trigger the capturing of an individual image.

Electric field sensing may be used to detect activity near the user even when there is very little movement or activity by the user. One example may be when the user is sitting in a public location (e.g., a train or airport terminal, a movie theater, a lecture hall, etc.). If other persons enter or leave the location, but the user stays relatively still, a photo may still be captured on the basis of being triggered by a detected change in electric field due to movement by the other people and/or electronic devices that those people carry. Another example of activity that may lead to detection of a change in electric field is when an appliance, light or other electrical device is turned on or off.

Electric field monitoring may be used for reasons other than or in addition to serving as a trigger for capturing an image. As an example, a low background electric field level could indicate that the device is outdoors and camera settings (e.g., white balance, shutter speed, etc.) may be optimized for outdoors photography.

Although certain embodiments have been shown and described, it is understood that equivalents and modifications falling within the scope of the appended claims will occur to others who are skilled in the art upon the reading and understanding of this specification.

What is claimed is:

1. A method of capturing and storing a digital image with a lifelog camera that is configured to capture the digital image without user input that commands the capturing of the digital image, comprising:
detecting a state transition in a signal from a sensor, the state transition indicative of a change in user activity;
capturing the digital image with a camera module of the lifelog camera, the capturing triggered by the detection of the state transition; and
storing the digital image in a memory.

2. The method of claim 1, further comprising detecting multiple transitions between respective stages of an activity sequence carried out by the user and, for each detected transition, capturing and storing an image.

3. The method of claim 1, further comprising monitoring multiple signals each from a respective sensor and the detecting made if any one of the signals undergoes a state transition indicative of a change in user activity.

4. The method of claim 1, further comprising monitoring multiple signals each from a respective sensor and the detecting made if changes in two or more of the signals are together indicative of the change in user activity.

5. The method of claim 1, wherein the sensor comprises at least one of a motion sensor that detects motion of the user, a biometric sensor, an electric field sensor, or a magnetic field sensor.

6. A method of capturing and storing a digital image with a lifelog camera that is configured to capture the digital image without user input that commands the capturing of the digital image, comprising:
detecting a state transition in a signal from an electric field sensor or a magnetic field sensor, the state transition indicative of one of a change in user activity or a change in activity near the user;
capturing the digital image with a camera module of the lifelog camera, the capturing triggered by the detection of the state transition; and
storing the digital image in a memory.

7. The method of claim 6, further comprising monitoring the signal from the electric field sensor or the magnetic field sensor and monitoring a signal from an additional sensor, the detecting made if changes in the monitor signals are together indicative of the change in activity.

8. The method of claim 7, wherein the additional sensor comprises at least one of a motion sensor that detects motion of the user or a biometric sensor.

9. A lifelog camera that is configured to capture a digital image without user input that commands the capturing of the digital image, comprising:
a control circuit configured to detect a state transition in a signal from a sensor, the state transition indicative of a change in user activity;
a camera module that captures the digital image under the control of the control circuit in response to the detection of the state transition; and
a memory in which the digital image is stored.

10. The lifelog camera of claim 9, wherein the control circuit is further configured to detect multiple transitions between respective stages of an activity sequence carried out by the user and, for each detected transition, command the capture and storage of an image.

11. The lifelog camera of claim 9, wherein the control circuit is further configured to monitor multiple signals each from a respective sensor and the camera module is commanded to capture the digital image if any one of the signals undergoes a state transition indicative of a change in user activity.

12. The lifelog camera of claim 9, wherein the control circuit is further configured to monitor multiple signals each from a respective sensor and the camera module commanded to capture the digital image if changes in two or more of the signals are indicative of the change in user activity.

13. The lifelog camera of claim 9, wherein the sensor comprises a motion sensor that detects motion of the user.

14. The lifelog camera of claim 9, wherein the sensor comprises a biometric sensor.

15. The lifelog camera of claim 14, wherein the biometric sensor comprises at least one of a galvanic skin response sensor or a pulse rate monitor.

16. The lifelog camera of claim 9, wherein the sensor comprises at least one of an electric field sensor or a magnetic field sensor.

17. A lifelog camera that is configured to capture a digital image without user input that commands the capturing of the digital image, comprising:
a control circuit configured to detect a state transition in a signal from an electric field sensor or a magnetic field sensor, the state transition indicative of one of a change in user activity or a change in activity near the user;
a camera module that captures the digital image under the control of the control circuit in response to the detection of the state transition; and
a memory in which the digital image is stored.

18. The method of claim 17, wherein the control circuit is further configured to monitor the signal from the electric field sensor or the magnetic field sensor and monitor a signal from an additional sensor, the camera module commanded to capture the digital image if changes in the monitor signals are together indicative of the change in activity.

19. The method of claim 18, wherein the additional sensor comprises at least one of a motion sensor that detects motion of the user or a biometric sensor.
